(19) United States
(12) Patent Application Publication
(10) Pub. No.: US 2014/0058805 A1
(43) Pub. Date: Feb. 27, 2014

(54) REMOTELY AUTHORIZING A PURCHASE FROM A HEAD UNIT OF A VEHICLE

(71) Applicants: Henrik Paesler, Sunnyvale, CA (US); Aaron Williams, San Jose, CA (US); Prerna Jindia, Sunnyvale, CA (US); Isuru Warnakulasooriya, Mountain View, CA (US); Binh Tran, San Jose, CA (US); Kitty Yue, San Mateo, CA (US); Wei-Wei Lin, Fremont, CA (US); Kim Srea Phorn, San Jose, CA (US); Geoff Ryder, Menlo Park, CA (US)

(72) Inventors: Henrik Paesler, Sunnyvale, CA (US); Aaron Williams, San Jose, CA (US); Prerna Jindia, Sunnyvale, CA (US); Isuru Warnakulasooriya, Mountain View, CA (US); Binh Tran, San Jose, CA (US); Kitty Yue, San Mateo, CA (US); Wei-Wei Lin, Fremont, CA (US); Kim Srea Phorn, San Jose, CA (US); Geoff Ryder, Menlo Park, CA (US)

(73) Assignee: SAP AG, Walldorf (DE)

(21) Appl. No.: 13/593,947

(22) Filed: Aug. 24, 2012

(51) Int. Cl. G06Q 20/40; G06Q 20/20; G06Q 20/16; G06Q 50/30

(52) U.S. Cl. 705/13; 705/44; 705/21

(57) ABSTRACT

Example systems and methods for authorizing a financial charge from the head unit of a vehicle are shown, in m example, vehicle position information is received from the head unit at a cloud server. The cloud server can also receive purchase information from the head unit of the vehicle. The cloud server can then verify that the purchase is appropriate given a location of the vehicle, based on the purchase information and the vehicle position information, and pass the purchase information to a credit or debit card processor when the purchase has been verified.

### TECHNICAL FIELD

This document generally relates to systems and methods for use with vehicles. More specifically, this document relates to remotely authorizing a purchase from a head unit of a vehicle.

### BACKGROUND

There are a number of different financial transactions that drivers execute while driving or sifting in a vehicle. During these transactions, the driver needs to pull out their wallet and hand their credit card, debit card, or cash to a cashier or insert it into a machine. Additionally, m the case of fuel pumps or charging stations, the drive must typically exit the vehicle to pay. Many times this can occur in inclement weather, such as rain, snow, wind, cold, hail, and the like. Furthermore, such transactions, specifically in the case of credit card and debit card transactions, present a fraud risk on the part of the merchant, who must bear the risk that the person attempting the transaction is not the true owner of the credit card or debit card.

### BRIEF DESCRIPTION OF DRAWINGS

The present disclosure is illustrated by way of example and not limitation in the figures of the accompanying drawings, in which like references indicate similar elements and in which:

FIG. 1 is a system diagram illustrating various components of a system, in accordance with an example embodiment, for providing remote purchase authorization from the head unit of a vehicle.

FIG. 2 is a diagram illustrating the components of a cloud server, in accordance with one embodiment.

FIG. 3 is a diagram illustrating the architecture of a head unit, in accordance with one embodiment.

FIG. 4 is a diagram illustrating the process of remotely authorizing a transaction from a head unit of a vehicle, in accordance with an example embodiment.

FIG. 5 is a diagram illustrating the process of remotely authorizing a transaction from a head unit of a vehicle, in accordance with another example embodiment.

FIG. 6 is a flow diagram illustrating a method, in accordance with an example embodiment.

FIG. 7 is a flow diagram illustrating a method, in accordance with another example embodiment.

FIG. 8 is a block diagram of a computer processing system at a server system, within which a set of instructions, for causing the computer to perform any one or more of the methodologies discussed herein, may be executed.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

The embodiments described herein provide techniques for providing a system that allows a head unit of vehicle to authorize a financial transaction. Many vehicles are now connected to the Internet or other network via wireless mechanisms. For example, electric vehicles often contain a SIM card and are able to send information to a central server via a cell phone network (or are simply able to directly communicate via, for example. Code Division Multiple access, or CMDA). In an example embodiment, this connectivity is leveraged to allow the user to authorize a purchase from the head unit of a car itself negating the need for the user to exit the vehicle to conduct the transaction as well as negating the need for the user to retrieve a physical wallet. Furthermore, because the payment information is tied to the vehicle itself, fraud is much less likely because a thief could not just steal credit card information or a small card or device, but would need to steal the entire vehicle itself in order to conduct a transaction using the head unit of the vehicle. This makes it much safer on the part of the merchant and aids in the process of merchants integrating this technology into their establishments. Thus, in an example embodiment, the purchase involves an item or service that requires the vehicle to be present to gain the benefit of the purchase (such as a charging/refueling station, parking meter, toll booth, or drive-thru area of a last rood restaurant), even If the purchase were made through traditional means.

A head unit of a ear is a device located in the car that provides information to the driver. It is typically located in or above a center console in the vehicle, visible to the driver while driving. It is common for a global positioning system (GPS) module to be embedded in, or in communication with, this head unit to provide real-time location and maps to the driver. Additional functionality is commonly incorporated into the head unit, such as car stereo controls, air conditioning and heating controls, and status information about the vehicle. For example, in an electric vehicle, it is common for the head unit to display charge status of the car battery, as well as miles remaining until a recharge is necessary.

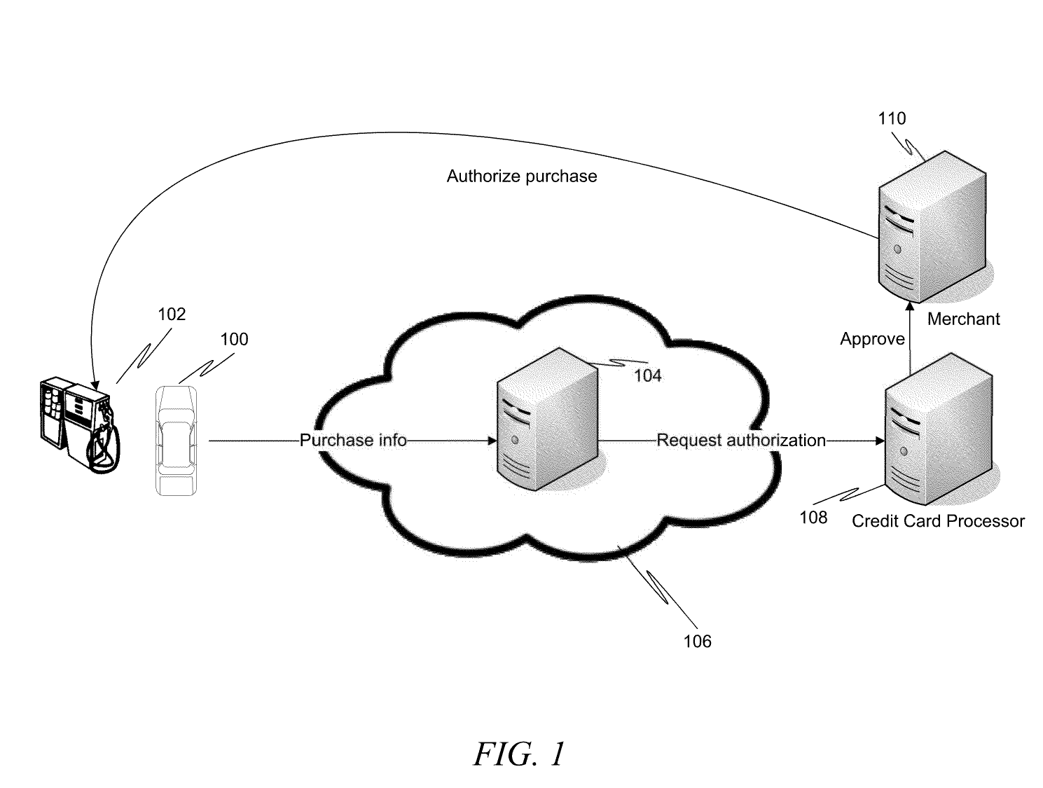

Certain embodiments are described herein as including logic or a number of components, modules, or mechanisms. FIG. 1 is a system diagram illustrating various components of a system, in accordance with an example embodiment, for providing remote purchase authorization from the head unit of a vehicle, A vehicle, such as car 100, may arrive at a participating location, such as a refueling pump 102. As will be described below, the detection that the car 100 has arrived at the refueling pump 102 may be performed in a number of different ways. In an example embodiment, a GPS unit in the car 100 may be used to determine the current location of the car 100, and that location may be compared against a database of participating merchant locations, such as refueling pump 102. A driver of the car 100 may then request a purchase of an item or service at the refueling pump 102. This information may be sent to a cloud server 104 located in cloud 106.

The cloud server 104 may verify that the ear 100 is indeed at the participating location, and assuming it is, may send a request for authorization to a credit card processor 108. The credit card processor can then approve the charge and alert merchant 110 of the approval. The merchant 110 may then notify the refueling pump 102 that the purchase has been authorized, and the refueling pump 102 may then complete the transaction (e.g., allow the driver to refuel the ear 100).

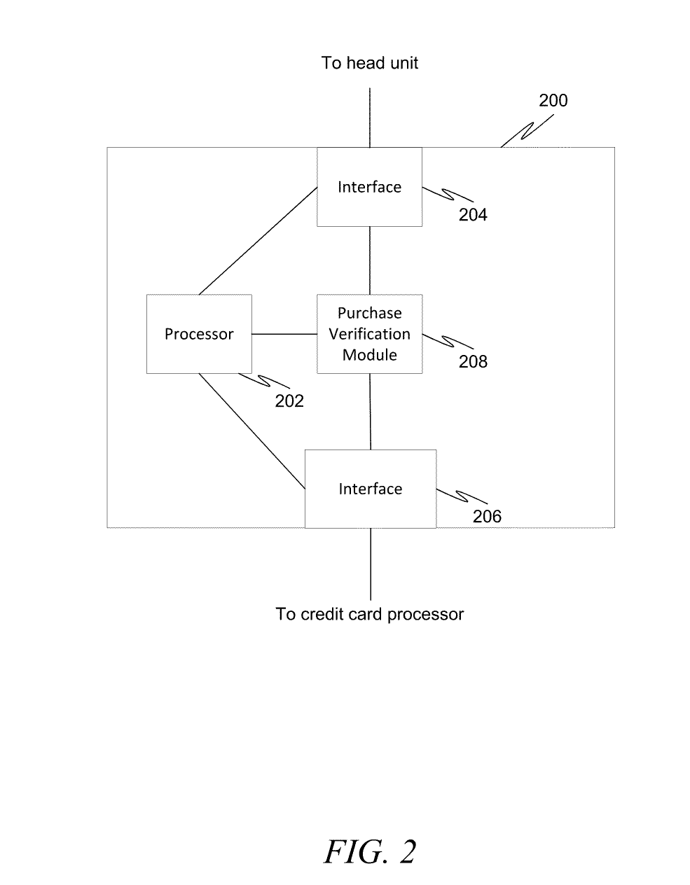

FIG. 2 is a diagram illustrating the components of a cloud server, in accordance with one embodiment. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., the server 200) or one or more hardware modules of a computer system (e.g., a processor 202 or a group of processors) may be configured by software (e.g., an application or application portion) as a hardware module that operates to perform certain operations as described herein. The modules may include an interface 204 designed to interface with the head unit of a vehicle (not pictured). Additionally, the modules may also include an interface 206 designed to interface with a credit card or debit card processor (not pictured). A purchase verification module 208 can then determine if a purchase is authorized based on the vehicle location sent from the head unit.

In various embodiments, a hardware module may be implemented mechanically or electronically. For example, a hardware module may include dedicated circuitry or logic that is permanently configured (for example, as a special-purpose processor, such as a field-programmable gate array (FPGA) or an application-specific integrated circuit (ASIC)) to perform certain operations. A hardware module may also include programmable logic or circuitry (for example, as encompassed within a general-purpose processor 202 or other programmable processor) that is temporarily configured by software to perform certain operations. It will be appreciated that the decision to implement a hardware module mechanically, in dedicated and permanently configured circuitry or in temporarily configured circuitry (for example, configured by software), may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules include a general-purpose processor 202 that is configured using software, the general-purpose processor 202 may be configured as respective different hardware modules at different times. Software may accordingly configure a processor 202, for example, to constitute a particular hardware module at one instance of time and to constitute a different hardware module at a different instance of time.

Modules can provide information to, and receive information from, other modules. For example, the described modules may be regarded as being communicatively coupled. Where multiples of such hardware modules exist contemporaneously, communications may be achieved through signal transmissions (such as, for example, over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices, and can operate on a resource (for example, a collection of information).

The various operations of example methods described herein may be performed, at least partially, by one or more processors 202 that are temporarily configured (e.g., by software) or permanently configured to perform the relevant operations. Whether temporarily or permanently configured, such processors 202 may constitute processor-implemented modules that operate to perform one or-more operations or functions. The modules referred to herein may, in some example embodiments, include processor-implemented modules.

Similarly, the methods described herein may be at least partially processor-implemented. For example, at least some of the operations of a method may be performed by one or more processors 202 or processor-implemented modules. The performance of certain of the operations may be distributed among the one or more processors 202, not only residing within a single machine but deployed across a number of machines. In some example embodiments, the processors 202 may be located in a single location (e.g., within a home environment, within an office environment, or as a server farm), while in other embodiments, the processors 202 may be distributed across a number of locations.

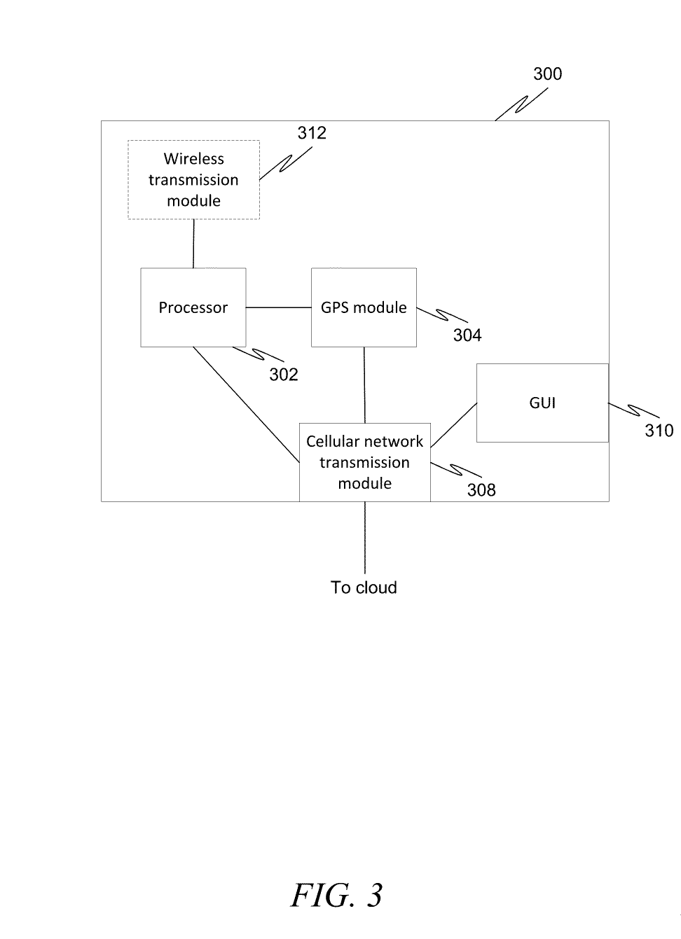

FIG. 3 is a diagram illustrating the architecture of a head unit, in accordance with one embodiment. Here, head unit 300 may contain one or more processors 302 and a GPS module 304. Furthermore, a cellular network transmission module 308 may receive vehicle location information from the GPS module 304, as well as purchase authorization or initiation commands from a graphical user interface (GUI) 310, and send Ibis information to the cloud for processing.

In an example embodiment, the head unit 300 offers an option to the user to press a button on the GUI 310 when the GPS module 304 detects that the vehicle has arrived at a participating location. For example, the head unit 300 may be programmed with preset locations representing refueling stations, charging stations, fast food restaurants, toll booths, and the like, that have arranged with the cloud service to provide remote head unit authorization of purchases. Alternatively, participating locations may be periodically communicated wirelessly to the head unit. Alternatively, the cloud server itself could monitor the location of the vehicle via updates received from the head unit 300, and determine that the vehicle is at a participating location.

Regardless, upon arriving at a participating location, the user may be prompted to activate a remote purchase for a transaction. In an example embodiment, the driver can enter the purchase amount via the GUI 310. In another example embodiment the head unit 300 can receive the purchase amount wirelessly from a local merchant, or from the cloud server (which itself may have received the purchase amount from a merchant).

The GUI 310 may include a touch screen that allows, for example, a virtual keyboard to aid the user in entering purchase information.

In embodiments where the head unit 300 receives purchase information directly from a local merchant (as opposed to receiving it directly from the user via the GUI 310, or from the cloud server), the head unit may include a wireless transmission module 312 capable of communicating wirelessly with a local merchant. This wireless transmission module 312 may utilize one or more wireless communication protocols capable of local transmission, such as IEEE 802.11 (WiFi), Near-Field Communication (NFC), and/or Bluetooth.

In one embodiment, the vehicle is constantly (or nearly so) connected to a cloud-based service. Typically this cloud-based service would provide support services to the vehicle, such as showing nearby charging stations in the case of electric vehicles. In a more particular embodiment, this cloud-based service is extended to also provide an authorization service to allow the transaction from the comfort of the car. The cloud-based service may also be informed as to the location of the vehicle through, for example, a GP module in the car. This would provide an additional layer of security not available in traditional financial transactions, as the location of the vehicle itself could be verified. Merely knowing one's credit card number, for example, would not be enough for a thief to make an unauthorized charge; the thief would also have to be in possession of the vehicle itself. Furthermore, since the cloud-based service would then inherently be able to track the vehicle, any such theft of the vehicle itself would be unlikely, or at least unlikely to last long enough for a thief to use the vehicle to make unauthorized purchases. This added security provides tremendous benefit over prior art techniques.

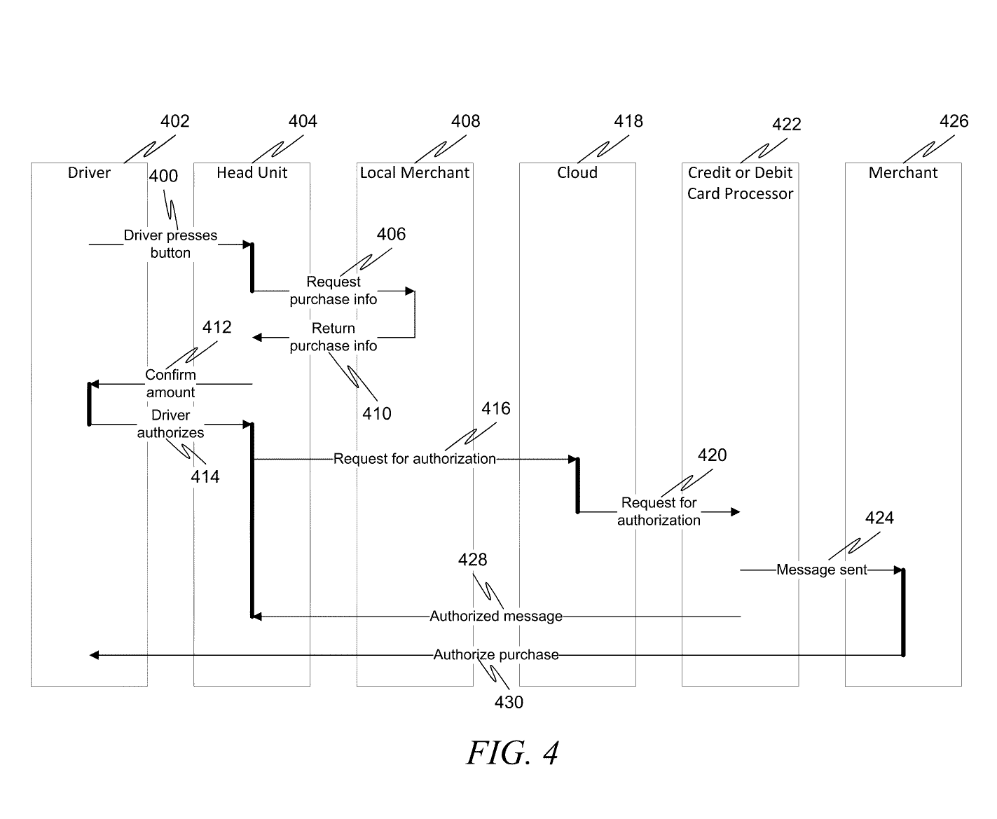

FIG. 4 is a diagram illustrating the process of remotely authorizing a transaction from a head unit of a vehicle, in accordance with an example embodiment. At 400, the driver 402 presses a button for the merchant on the head unit 404 of a vehicle. The head unit 404 could then wirelessly communicate 406 with the local merchant 408 to obtain purchase information, such as the amount of the transaction. The local merchant 408 could then return the purchase information at 410. At 412, the head unit 404 could then prompt the driver 402 to confirm the amount. At 414, the driver could press a button authorizing the charge. At 416, the head unit 404 could then send a request for authorization for the transaction to the cloud 418. The cloud 418 could then then send the request for authorization at 420 to the credit card processor 422, who could then authorize the transaction and send, an approval message 424. Additionally, a message may be sent to the merchant 426 informing them of the transaction, it should be noted that the merchant 426 Is depicted as separate from local merchant 408 because It may be the case that the merchant 426 is a nationwide office or server for the merchant but the local merchant 408 is a local franchisee or simply a local presence. One of ordinary skill in the art will recognize, however, that merchant 426 and local merchant 408 may In fact be a single entity, despite what is pictured in this figure. In one embodiment the local merchant 408 may include a point-of-sale terminal.

At 428, the credit card processor 422 can send the authorized message to the bead unit 404 through the cloud 418. Additionally, merchant 426 can authorize the purchase from their end at 430. This can take a number of forms. In the case of a fast food transaction, for example, the merchant 426 can notify the cashier that the purchase has been completed and that the food can be delivered. The driver may even be able to skip the window designated for the cashier and proceed directly to a window where the food is delivered. In the case of a refueling or charging station, the merchant 426 can activate the pump or charger.

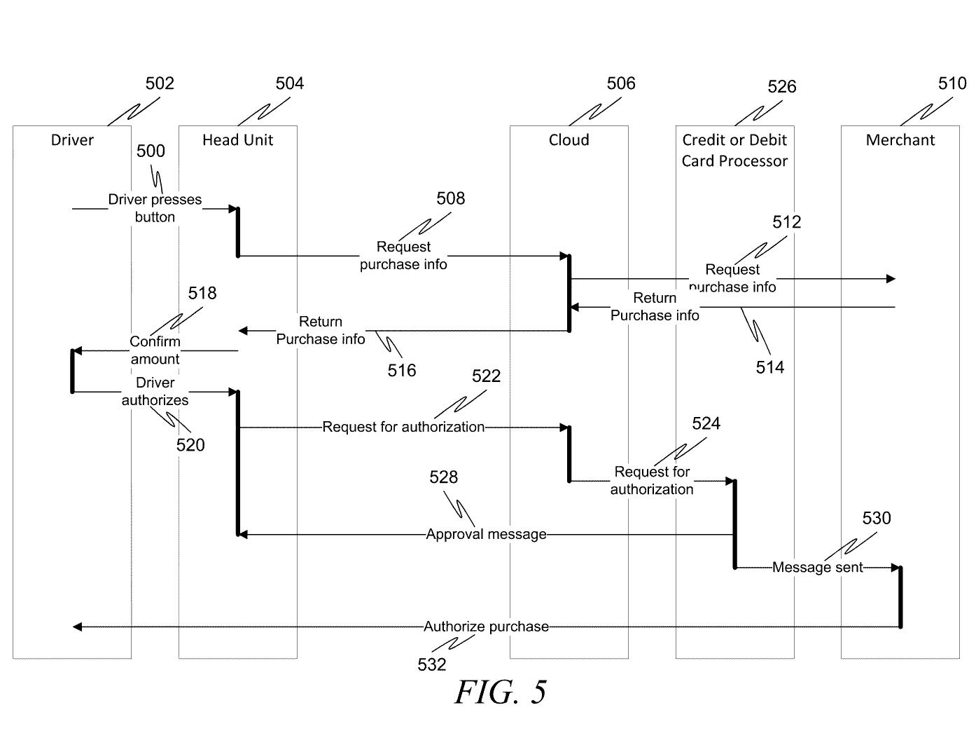

FIG. 5 is a diagram illustrating the process of remotely authorizing a transaction from a head unit of a vehicle, in accordance with another example embodiment. At 500, the driver 502 presses a button for the merchant on the head unit 504 of a vehicle. Here, the head unit 504 is unable to wirelessly communicate with the local merchant, either due to the design of the head unit 504 or because the local merchant does not have the technology installed to communicate wirelessly with the head unit directly. In such a case, the head unit requests a purchase at 508 from the cloud 506. The cloud 506 then can contact the merchant 510 at 512 to request purchase information. This allows the system to essentially communicate wirelessly between the head unit 504 and the local merchant 510 despite the fact that the local merchant 510 does not have the ability to communicate directly with the head unit 504. At 514, the merchant 510 could return the purchase information to the cloud 506, which then returns the amount at 516 to the head unit 504. The head unit 504 could then prompt the driver 502 at 518 to confirm the amount. At 520, the driver could press a button authorizing the change. At 522, the head unit 504 could then send a request for authorization for the transaction to the cloud 506. The cloud 506 could then then send the request for authorization at 524 to the credit card processor 526, who could then authorize the transaction and send an approval message 528. The cloud 506 can send the approval authorized message to the head unit 504. The credit card processor 526 can send a message 530 to the merchant 510 indicating approval of the charge. Merchant 510 can authorize the purchase from their end at 532. This can take a number of forms. As described above, in the case of a fast food transaction, for example, the merchant 510 can notify the cashier that the purchase has been completed and that the food can be delivered. The driver may even be able to skip the window designated for the cashier and proceed directly to a window where the food is delivered. In the case of a refueling or charging station, the merchant 510 can activate the pump or charger.

In some embodiments it may he beneficial, for anti-fraud purposes, to verify the purchase prior to authorizing it. While credit card companies often will make their own determinations of whether a charge is fraudulent or not, they do not have certain information at their disposal. Specifically, in an embodiment, the verification can include examining the location of the vehicle from which the purchase is being attempted, based on the GPS information transmitted from the vehicle to the cloud. This allows the aforementioned added security based on the fact that the purchase may only be authorized if it is appropriate for the given location (usually, that the purchase is for products or services located at that same location). In some embodiments, this verification may be performed at a cloud server in the cloud, but in other embodiments, the vehicle position information can he forwarded to the credit card processor tor them to make their own anti-fraud determinations based on the vehicle location information.

It should be noted that this verification is not limited only to vehicle position information. Any information about the vehicle that can be passed to the cloud can be used tor verification. In different circumstances, different information may be relevant. For example, if the purchase is for 15 gallons of fuel and the vehicle already has a full tank, then the system could reject the purchase.

The verification need not be limited to just anti-fraud verification. It can also be made to ensure driver safety or the appropriateness of the transaction tor the vehicle. For example, if the driver is attempting to purchase fuel that is of a lower octane than recommended by the manufacturer of the vehicle, the purchase may be rejected and the driver notified.

One embodiment may be specifically geared for use in electric vehicles. Electric vehicle drivers currently need to tap a radio frequency identification (RFID) card or swipe a credit card at the charging station. Indeed, RFID cards are required most of the time. Unfortunately, this means a different RFID card for each charge spot provider, and there are many charge spot providers in the United States and Europe. Additionally, many electric vehicle drivers, such as taxi drivers or government workers, have to do this on a daily basis due to the amount of travel they perform. As such, dealing with inclement weather is even more of a concern.

As such, an embodiment would replace the RFID cards with an interface at the head unit, which could communicate with the charge spot provider via the cloud.

In another embodiment, the head unit may communicate with providers of parking meters in order to arrange for the payment of parking fees. Currently, the use of parking meters can be quite frustrating for the driver, who must attempt to accurately guess how long they will be parked in the spot. If they guess too high, they wind up paying for more time than they need. If they guess too low, then they wind up having to come back to the spot prior to the time expiration and feed more coins into the meter.

Modern parking meters allow for payment via credit card or debit card. However, the problem of paying for the meter still remains. One solution would be for the parking meter to be able to contact the driver (such as via a text message to a cell phone) to remind him or her that their time has almost expired and asking whether they wish to pay for more time. This would at least have the advantage of not requiring the driver's return to the spot to pay for more time. There also then remains the problem of when the system would stop sending such reminders. Unless there is a specific button or other mechanism on the parking meter to detect when the driver is leaving the spot, the parking meter has no way of knowing that the vehicle has left the spot, and thus no way to know when to stop reminding the driver to pay for more time.

In one embodiment, the head unit of the vehicle can authorise the payment of more time for the parking meter even if the driver is not present in the vehicle. This would allow the driver to continue going about his day without needing to return to the vehicle until ready (or, at least not until a maximum amount of allowable time for the spot is utilized). The cloud is also aware of the location of the vehicle, which leads to the additional advantage in that the head unit would then not authorize any additional payments for a snot once the vehicle had left the spot.

Even more advantages could be realized with this embodiment. For example, it would he possible for the parking meter system to be designed to only charge drivers for the exact amount of time that they use. Modern parking meters are currently designed only to dole out time in pre-set increments, usually 6 minute, 15 minute, or 30 minute blocks. This leads to wasted money on the part of drivers, who must necessarily pay for more time than they need, unless they know when they are going to be leaving down to the second, which is impractical, in this example embodiment, the system could be designed to charge by the second, rather than by multi-minute chunks.

If a multi-minute chunk embodiment is maintained, then the system could be designed to cancel any remaining time left on the meter once the vehicle leaves the spot. Currently, if a driver estimates too long and pays for more time than they need, the next driver who parks in the spot is the beneficiary and gets a certain amount of “free” time. By cancelling the remaining time when the first driver's vehicle leaves the spot, this creates more potential revenue for the parking meter provider.

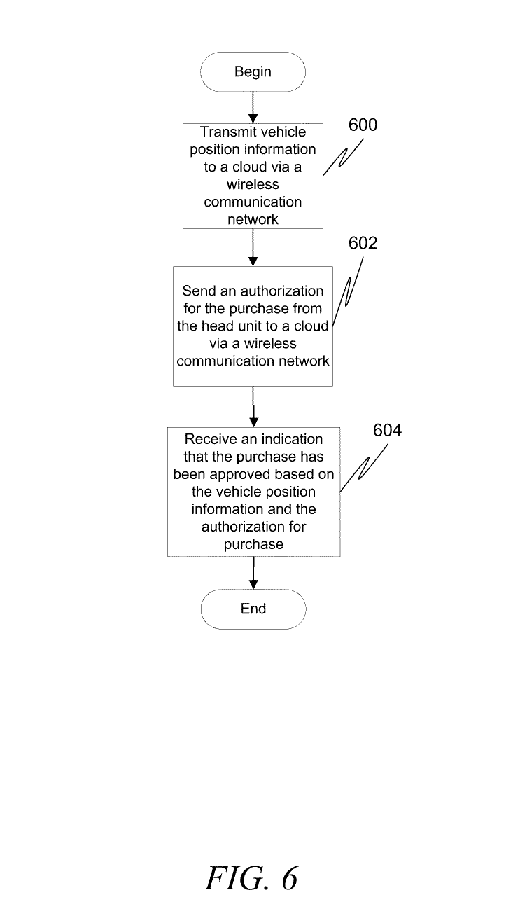

FIG. 6 is a flow diagram illustrating a method, in accordance with an example embodiment. At 600, vehicle position information is transmitted to a cloud via a wireless communication network. At 602, an authorization for the purchase is sent from the head unit to a cloud via a wireless communication network. At 604, an indication from the cloud that the purchase has been approved based on the vehicle position information and the authorization for purchase from the head unit is received

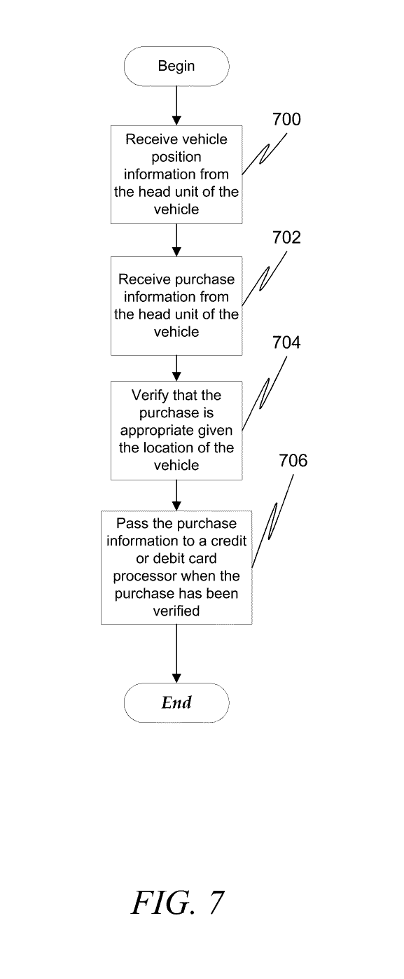

FIG. 7 is a flow diagram illustrating a method, in accordance with another example embodiment. At 700, vehicle position information from the head unit of the vehicle is received at a cloud server in a cloud. At 702, purchase information from the head unit of the vehicle is received by the cloud server. At 704, it is verified that the purchase is appropriate given a location of the vehicle, based on the purchase information and the vehicle position information. At 706, the purchase information is passed to a credit or debit card processor when the purchase has been verified.

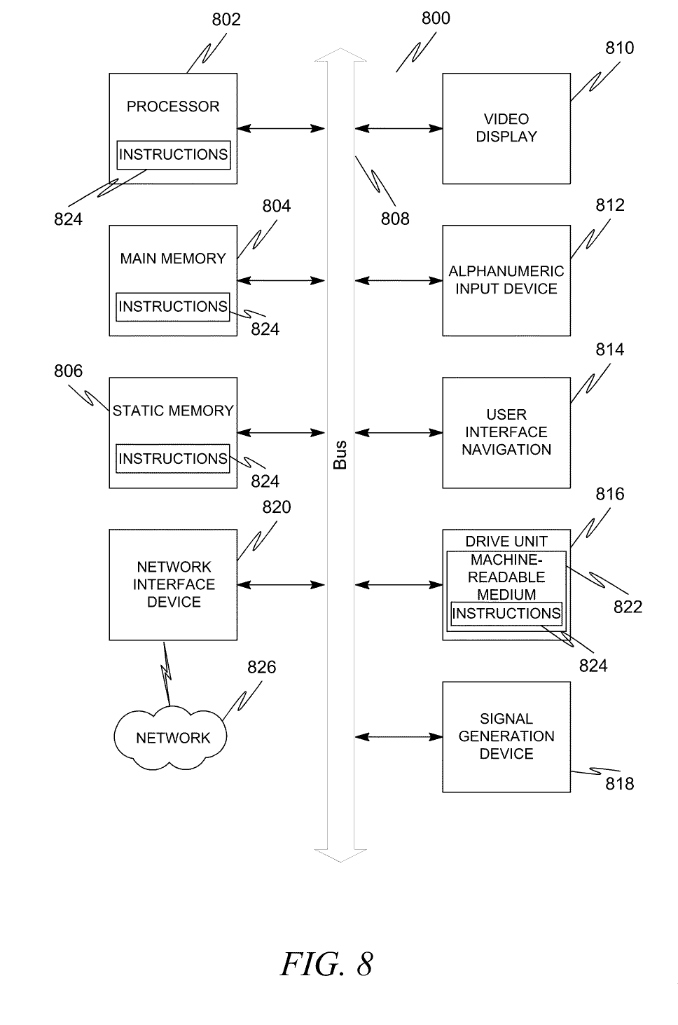

FIG. 8 is a block diagram of a computer processing system at a server system, within which a set of instructions, for causing the computer to perform any one or more of the methodologies discussed herein, may be executed.

Embodiments may also, for example, be deployed by Software-as-a-Service (SaaS), Application Service Provider (ASP), or utility computing providers, in addition to being sold or licensed via traditional channels. The computer may he a server computer, a personal computer (PC), a tablet PC, a set-top box (STB), a personal digital assistant (PDA), cellular telephone, or any processing device capable of executing a set of instructions (sequential or otherwise) that specify actions to he taken by that device. Further, while only a single computer is illustrated, the term “computer” shall also be taken to include any collection of computers that individually or jointly execute a set (or multiple sets) of instructions to perform any one or more of the methodologies discussed herein.

The example computer processing system 800 includes processor 302 (e.g., a central processing unit (CPU), a graphics processing unit (GPU) or both), main memory 804 and static memory 806, which communicate with each other via has 808. The processing system 800 may further include video display unit 810 (e.g., a plasma display, a liquid crystal display (LCD) or a cathode ray tube (CRT)). Use processing system 800 also includes alphanumeric input device 812 (e.g., a keyboard), a user interface (UI) navigation device 814 (e.g., a mouse, touch screen, or the like), a disk drive unit 816, a signal generation device 818 (e.g., a speaker), and a network interface device 820.

The disk drive unit 816 includes computer-readable medium 822 on which is stored one or snore sets of instructions and data structures (e.g., software 824) embodying or utilized by any one or more of the methodologies or functions described herein. The software 824 may also reside, completely or at least partially, within the main memory 804 and/or within the processor 802 during execution thereof by the processing system 800, the main memory 804 and the processor 802 also constituting computer-readable, tangible media.

The software 824 may further be transmitted or received over network 826 via a network interface device 820 utilizing any one of a number of well-known transfer protocols (e.g., Hypertext Transfer Protocol).

While the computer-readable medium 822 is shown in an example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions tor execution by the computer and that cause the computer to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, and optical and magnetic media.

While various implementations and exploitations are described, it will be understood that these embodiments are illustrative and that the scope of the claims, is not limited to them. In general techniques for maintaining consistency between data structures may be implemented with facilities consistent with any hardware system or systems defined herein. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the claims, in general, structures and functionality presented as separate components. In the exemplary configurations may be implemented as a combined structure or component. Similarly, structures and functionality presented as a single component may be implemented as separate components. These and other variations, modifications, additions, and improvements fall within the scope of the claims.

It should be noted that while this document discusses cars specifically as an example of a vehicle that can utilize various embodiments, the scope of the claims should not be interpreted to be limited to cars. Indeed any vehicle could benefit from various aspects of the embodiments described. This may include, but is not limited to, cars, trucks, motorcycles, bicycles, boats, airplanes, helicopters, spacecraft, and so forth. An additional, advantage is recognized when the purchase is related to the vehicle itself as the anti-fraud aspects are more prevalent. For example, while technically someone could utilize someone else's car to purchase an item that is only for their own benefit (such as a teenager borrowing a parent's car to purchase fast food without the parent's permission), if instead the item or service pertains only to the car (such as paying for refueling), it becomes harder to obtain only a personal benefit (i.e., one that benefits only the person separate and apart from the vehicle, such as purchasing food or clothing) for the purchase, and thus makes it less likely for a fraudulent transaction to be attempted.

While the embodiments are described with reference to various implementations and exploitations, it will be understood that these embodiments are illustrative, and that the scope of claims provided below is not limited to the embodiments described herein. In general the techniques described herein may be implemented with facilities consistent with any hardware system or systems defined herein. Many variations, modifications, additions, and improvements are possible.

The term “computer readable medium” is used generally to refer to media such as main memory, secondary memory, removable storage, hard disks, flash memory, disk drive memory, CD-ROMs, and other forms of persistent memory. It should be noted that program storage devices, as may be used to describe storage devices containing executable computer code for operating various methods, shall not be construed to cover transitory subject matter, such as carrier waves or signals. Program storage devices and computer readable medium are terms used generally to refer to media such as main memory, secondary memory, removable storage disks, hard disk drives, and other tangible storage devices or components.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the claims. In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the claims and their equivalents.

1. A method for authorizing a purchase from a head unit of a vehicle, comprising:
transmitting, by the head unit, vehicle position information to a cloud via a wireless communication network;
creating, by the head unit, an authorization for the purchase;
sending the authorization for the purchase from the head unit to a cloud via a wireless communication network; and
receiving an indication from the cloud that the purchase has been approved based on a determination that the purchase is appropriate given the location of the vehicle; and
completing the purchase based on the received indication.

2. The method of claim 1, wherein the vehicle position information is obtained from a global positioning system (GPS) module in the vehicle.

3. The method of claim 1 wherein the purchase is a purchase that would require a vehicle be present to gain benefit of the purchase.

4. The method of claim 1, further comprising;
receiving purchase amount information from a merchant via a wireless communication network.

5. A method for authorizing a purchase from a head unit of a vehicle, comprising:
receiving, at a cloud server in a cloud, vehicle position information from the head unit of the vehicle;
receiving, at the cloud server, purchase information from the head unit of the vehicle, the purchase information including a location where the purchase is taking place;
comparing the vehicle position information to the location where the purchase is taking place to verify that the purchase is appropriate given a location of the vehicle; and
passing the purchase information to a credit or debit card processor in response to a verification that the purchase is appropriate .given the location of the vehicle, in order to cause the processing of a financial transaction for the purchase.

6. The method of claim 5, further comprising alerting a driver by sending a message to the head unit.

7. The method of claim 5, wherein the purchase is time from a parking meter.

8. The method of claim 7, wherein the purchase is prompted by an alert from the parking meter that time on the parking meter has almost expired.

9. A cloud server located in a cloud, the cloud server comprising:
a processor;
a first interface designed to receive vehicle position information and purchase information from a head unit, of a vehicle, the purchase information including a location where a purchase is taking place;
a purchase verification module configured to compare the vehicle position information to the location where the purchase is taking place to verify that the purchase is appropriate given a location of the vehicle; and
a second interface designed to send the purchase information to a transaction processor in response to a verification that the purchase is appropriate given the location of the vehicle, in order to cause the processing of a financial transaction for the purchase.

10. The cloud server of claim 9, wherein the first interlace includes an interface to a cellular phone network.

11. The cloud server of claim 9, further comprising a third interface designed to send purchase information to a merchant.

12. The cloud server of claim 11 wherein the merchant includes a merchant server in communication with a local point-of-sale terminal at the location of the vehicle.

13. A head unit in a vehicle, comprising:
a processor;
a global positional satellite (GPS) module designed to determine a current location for the vehicle;
the processor configured to create an authorization for a purchase, the authorization including vehicle position information from the GPS module;
a cellular network transmission module designed to transmit the authorisation to a cloud via a wireless communication message and to complete the purchase upon receiving an indication from the cloud that the purchase has been approved based on a determination that the purchase is appropriate given the location of the vehicle.

14. The head unit of claim 13, further comprising a direct wireless transmission module designed to communicate directly with a point of sale terminal at the current location.

15. A non-transitory computer-readable storage medium comprising instructions that, when executed by at least one processor of a machine, cause the machine to per form operations for authorizing a purchase from a head unit of a vehicle, comprising:
transmitting, by the head unit, vehicle position information to a cloud via a wireless communication network;
sending the authorization for the purchase from the head unit to a cloud via a wireless communication network;
receiving an indication from the cloud that the purchase has been approved based on a determination that the purchase is appropriate given the location of the vehicle; and
completing; the purchase based on the received indication.

16. A non-transitory computer-readable storage medium comprising instructions that, when executed by at least one processor of a machine, cause the machine to perform operations for authorizing a purchase from a head unit of a vehicle, comprising:
receiving, at a cloud server in a cloud, vehicle position information from the head unit of the vehicle;
receiving, at the cloud server, purchase information from the head unit of the vehicle, the purchase information including a location where the purchase is taking place;
comparing the vehicle position information to the location where the purchase is taking place to verify that the purchase is appropriate given a location of the vehicle; and
passing the purchase information to a credit or debit card processor in response to a verification that the purchase is appropriate given the location of the vehicle, in order to cause the processing of a financial transaction for the purchase.
